(19) United States
(12) Patent Application Publication
(10) Pub. No.: US 2014/0225368 A1
(43) Pub. Date: Aug. 14, 2014

(54) FASTENING DEVICE FOR COMBINING A PRESSURE GAUGE ON AN AIR PUMP

(71) Applicant: Wei-Chi Wang, Tainan (TW)

(72) Inventor: Wei-Chi Wang, Tainan (TW)

(21) Appl. No.: 13/762,726

(22) Filed: Feb. 8, 2013

(51) Int. Cl. F16L 21/08

(52) U.S. Cl. CPC F16L 21/08
USPC 285/404

(57) ABSTRACT

A fastening device for combining a pressure gauge on an air pump has a connector, a three-way pipe, a screw and multiple fixers. The connector has a first fool-proof plane and a locating hole. The three-way pipe is mounted on the connector and has a second fool-proof plane facing the first fool-proof plane, a threaded hole being aligned with the locating hole, and multiple retaining holes. The screw is screwed through the threaded hole and a distal end of the screw is inserted into the locating hole to fix the three-way pipe on the connector. The fixers are respectively mounted through the retaining holes and are adapted to fix the pressure gauge on the three-way pipe. Accordingly, the fastening device prevents the pressure gauge from being deflective in its combination position and is easy to assemble and has a low labor cost.

### BACKGROUND OF THE INVENTION

1. Field of the Invention

The present invention relates to a fastening device, and more particularly to a fastening device for combining a pressure gauge on an air pump.

2. Description of Related Art

An air pump has a frame, a cylinder, a pedal, a fastening device and a pressure gauge. The cylinder is mounted on the frame and has a cylinder housing and a cylinder core. The cylinder core is mounted in the cylinder housing and protrudes out of a rear end of the cylinder housing. The pedal is pivotally mounted on the frame and is connected with the cylinder core. The fastening device has a first threaded portion and a three-way pipe. The first threaded portion is mounted on a front end of the cylinder housing. The three-way pipe has a second threaded portion for engaging the first threaded portion and a third threaded portion. The pressure gauge is mounted on the three-way pipe and has a fourth threaded portion for engaging the third threaded portion.

The fastening device connects the pressure gauge and the cylinder. The pressure gauge is screwed into the three-way pipe via the third threaded portion, and then the three-way pipe is screwed into the cylinder housing. Thus, the pressure gauge is easily deflective in its combination position. Therefore, a user may tend to regard the pressure gauge as a default product and has difficulty reading a pressure value on the pressure gauge. Moreover, the fastening device for combining a pressure gauge on an air pump is inconvenient in assembly and has a high labor cost.

To overcome the shortcomings, the present invention tends to provide a fastening device to mitigate or obviate the aforementioned problems.

### SUMMARY OF THE INVENTION

The main objective of the invention is to provide a fastening device for combining a pressure gauge on an air pump to prevent the pressure gauge from being deflective in its combination position and is easy to assemble and has a low labor cost.

The fastening device for combining a pressure gauge on an air pump has a connector, a three-way pipe, a screw and multiple fixers. The connector is hollow and has a first fool-proof plane and a locating hole. The first fool-proof plane is formed on an outer surface of the connector. The locating hole is formed in the first fool-proof plane. The three-way pipe is mounted on the connector and has a second fool-proof plane, a threaded hole and multiple retaining holes. The second fool-proof plane is formed on an inner surface of the three-way pipe and faces the first fool-proof plane of the connector. The threaded hole is formed in an outer surface of the three-way pipe and is aligned with the locating hole of the connector. The retaining holes are formed in the outer surface of the three-way pipe. The screw is screwed through the threaded hole of the three-way pipe and a distal end of the screw is inserted into the locating hole of the connector. The fixers are respectively mounted through the retaining holes and are adapted to fix the pressure gauge on the three-way pipe.

When the three-way pipe is mounted on the connector, the first fool-proof plane faces the second fool-proof plane to prevent a relative rotation between the connector and the three-way pipe. The distal end of the screw is inserted into the locating hole of the connector to securely position the three-way pipe on the connector. The fixers are respectively mounted through the retaining holes of the three-way pipe and are further respectively screwed into the pressure gauge to fix the pressure gauge on the three-way pipe and prevent a relative rotation between the pressure gauge and the three-way pipe. Accordingly, the fastening device prevents the pressure gauge from being deflective in its combination position and prevents the pressure gauge from being regarded as a default product, and a pressure value on the pressure gauge is easy to be read. In addition, the fastening device is easy to assemble and has a low labor cost.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a fastening device for combining a pressure gauge on an air pump in accordance with the present invention;

FIG. 2 is a perspective view of the fastening device for combining a pressure gauge on an air pump in FIG. 1;

FIG. 3 is a top view of the fastening device for combining a pressure gauge on an air pump in FIG. 2;

FIG. 4 is a side view in partial section of the fastening device for combining a pressure gauge on an air pump in FIG. 2;

FIG. 5 is a perspective view of the fastening device for combining a pressure gauge on an air pump in FIG. 2 combined with a frame and a pedal; and

FIG. 6 is another perspective view of the fastening device for combining a pressure gauge on an air pump in FIG. 2 combined with a frame and a pedal.

### DETAILED DESCRIPTION OF PREFERRED EMBODIMENT

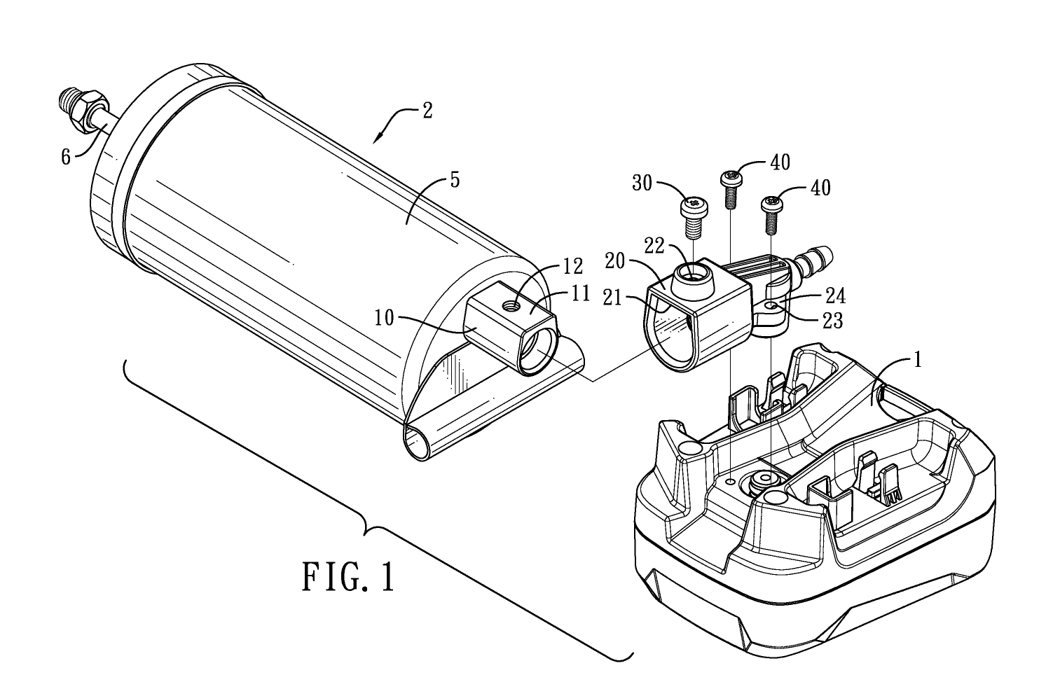

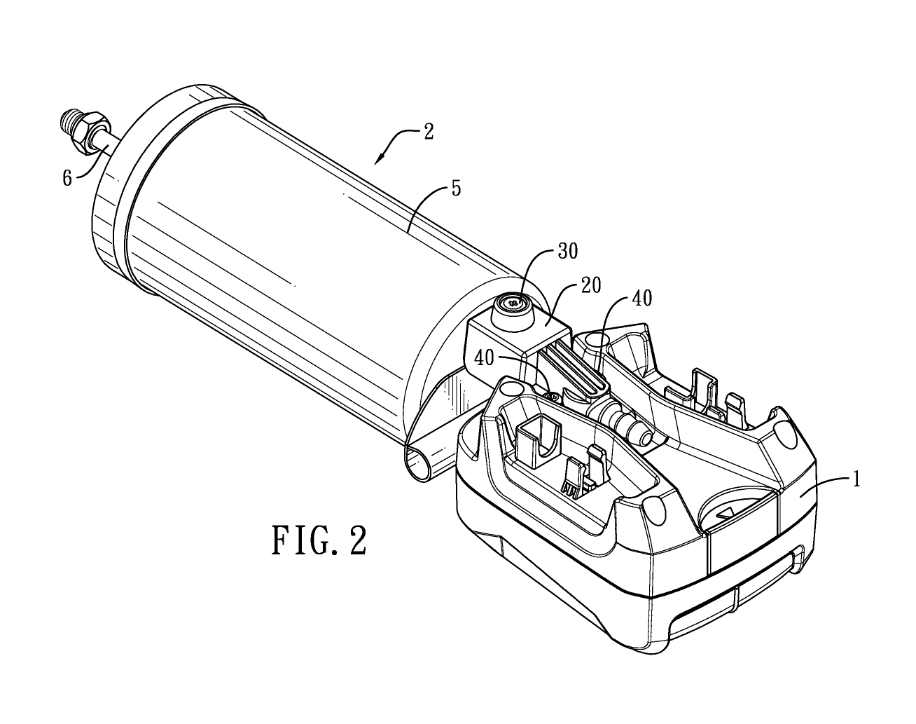

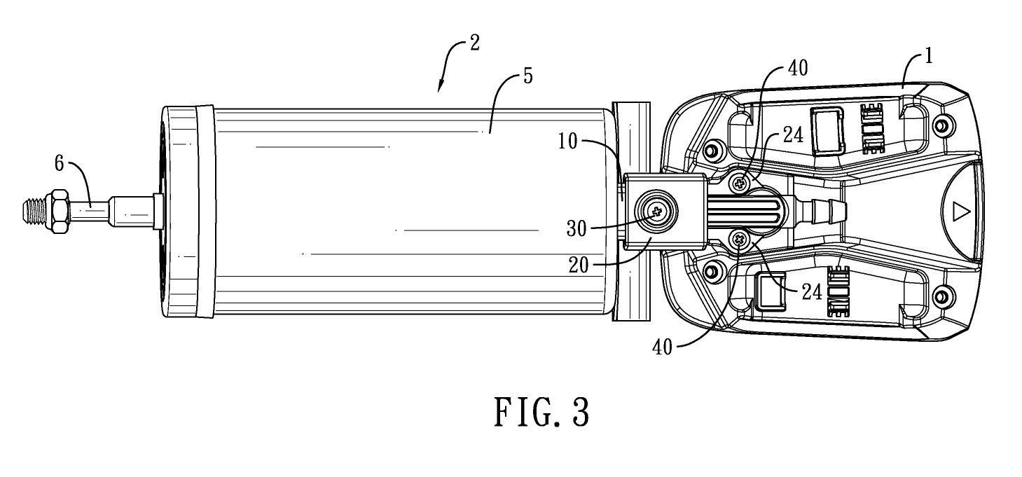

With reference to FIGS. 1 to 3, a fastening device for combining a pressure gauge on an air pump in accordance with the present invention comprises a connector 10, a three-way pipe 20, a screw 30 and multiple fixers 40. The fastening device is adapted to combine a pressure gauge 1 of the air pump with a cylinder 2 of the air pump.

The connector 10 is mounted on the cylinder 2 of the air pump and is hollow and in communication with the cylinder 2. The connector 10 has an outer surface, a first fool-proof plane 11 and a locating hole 12. The first fool-proof plane 11 is formed on the outer surface of the connector 10. The locating hole 12 is formed in the first fool-proof plane 11.

The three-way pipe 20 is mounted on the connector 10 and in communication with the connector 10 and the pressure gauge 1. The three-way pipe 20 has an inner surface, an outer surface, a second fool-proof plane 21, a threaded hole 22 and multiple retaining holes 23. The inner surface of the three-way pipe 20 faces the outer surface of the connector 10. The second fool-proof plane 21 is formed on the inner surface of the three-way pipe 20 and faces the first fool-proof plane 11 of the connector 10. The threaded hole 22 is formed in the outer surface of the three-way pipe 20 and is aligned with the locating hole 12 of the connector 10. The retaining holes 23 are formed in the outer surface of the three-way pipe 20. The three-way pipe 20 further has multiple wings 24 protruding from the outer surface of the three-way pipe 20. The retaining holes 23 are respectively formed through the wings 24.

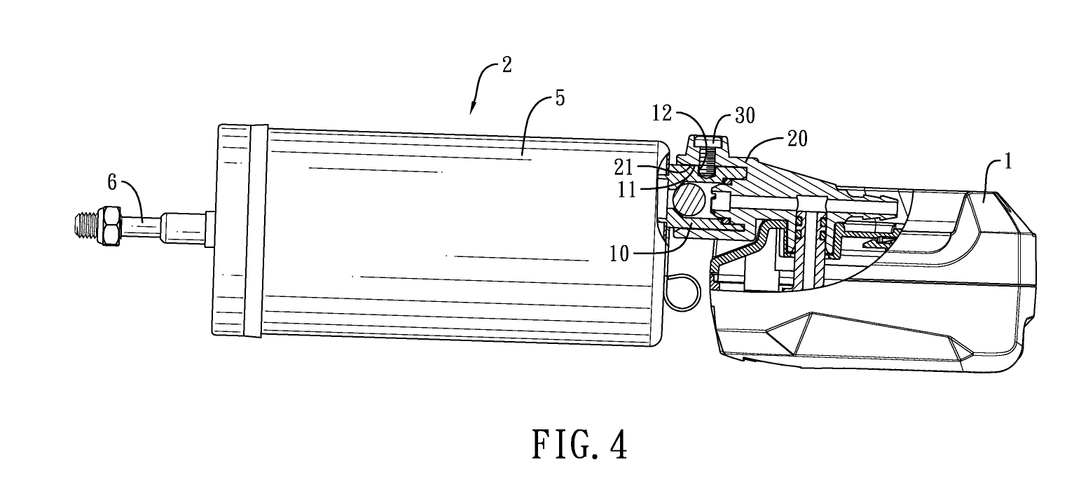

The screw 30 is screwed through the threaded hole 22 of the three-way pipe 20. With reference to FIG. 4, a distal end of the screw 30 is inserted into the locating hole 12 of the connector 10 to fix the three-way pipe 20 on the connector 10.

The fixers 40 are respectively mounted through the retaining holes 23 and are further screwed into the pressure gauge 1. The fixers 40 are adapted to fix the pressure gauge 1 on the three-way pipe 20.

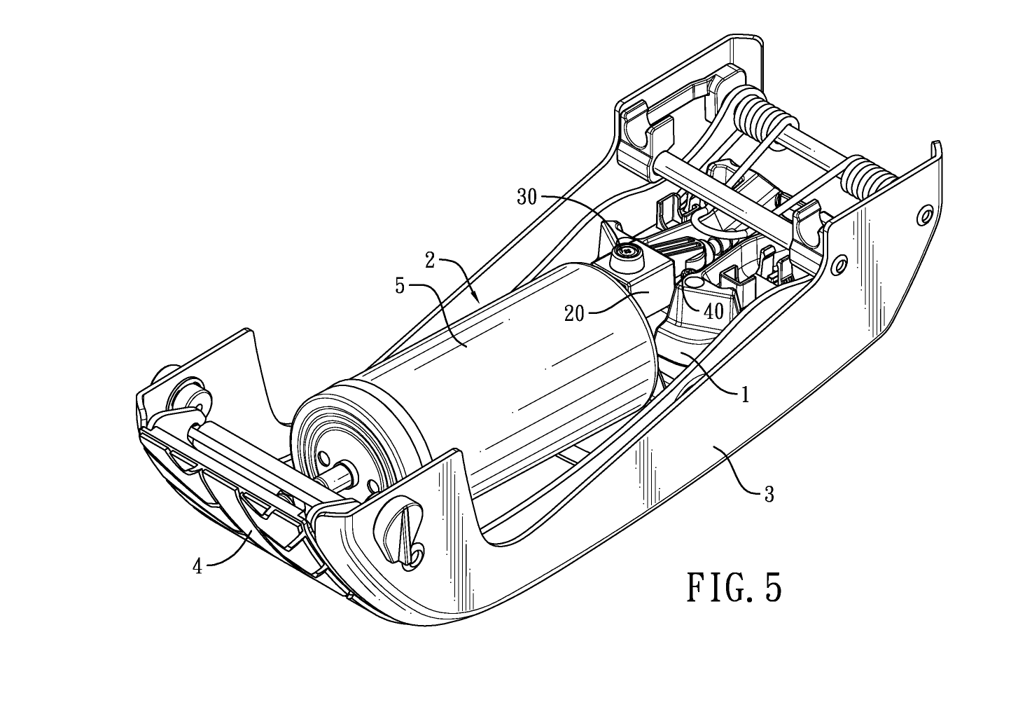

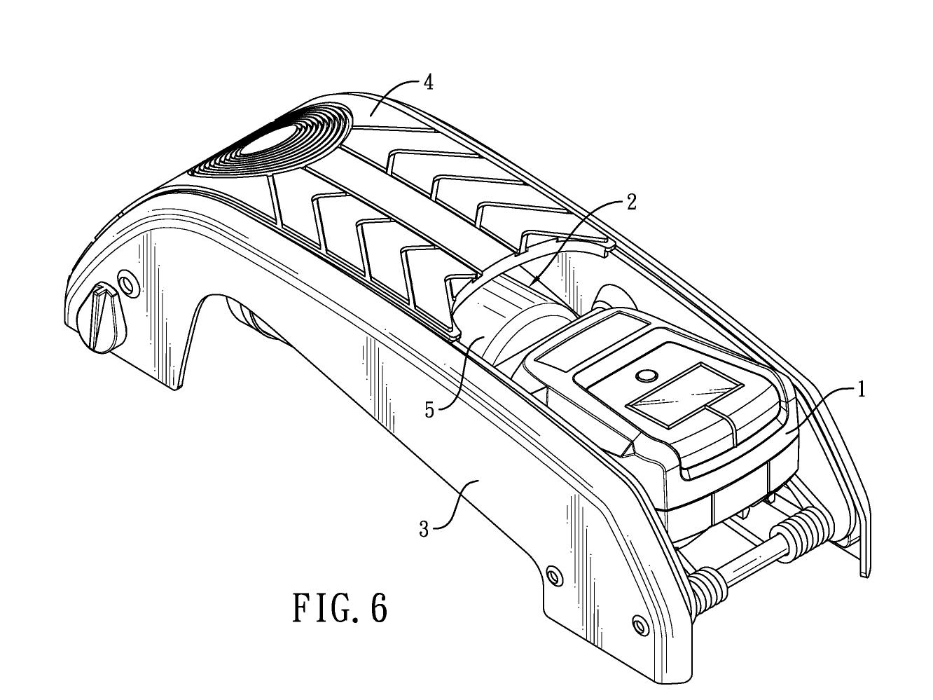

With reference to FIGS. 5 and 6, the air pump has a frame 3, the cylinder 2, a pedal 4, the fastening device and the pressure gauge 1. The cylinder 2 is mounted on the frame 3. The cylinder 2 has a cylinder housing 5 and a cylinder core 6 protruding out of a rear end of the cylinder housing 5. The pedal 4 is pivotally mounted on the frame 3 and is connected with the cylinder core 6. The fastening device is adapted to connect the pressure gauge 1 and the cylinder 2. The connector 10 is located on a front end of the cylinder housing 5 of the cylinder 2. The three-way pipe 20 is mounted on the connector 10 and is fixed by the screw 30, and then the first fool-proof plane 11 of the connector 10 faces the second fool-proof plane 21 of the three-way pipe 20 to prevent a relative rotation between the connector 10 and the three-way pipe 20. The pressure gauge 1 is set on the three-way pipe 20, and the fixers 40 are respectively mounted through the retaining holes 23 and screwed into the pressure gauge 1 to fix the pressure gauge 1 on the three-way pipe 20 and prevent a relative rotation between the three-way pipe 20 and the pressure gauge 1.

Accordingly, the fastening device can prevent the relative rotation between the connector 10 and the three-way pipe 20 and prevent the relative rotation between the three-way pipe 20 and the pressure gauge 1, and then a pressure value on the pressure gauge 1 is easy to be read, and the yield rate is improved. In addition, the fastening device is easy to assemble and has a low labor cost.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastening device for combining a pressure gauge on an air pump comprising:
a connector being hollow and having
an outer surface;
a first fool-proof plane formed on the outer surface of the connector; and
a locating hole formed in the first fool-proof plane;
a three-way pipe mounted on the connector and having
an inner surface;
an outer surface;
a second fool-proof plane formed on the inner surface and facing the first fool-proof plane of the connector;
a threaded hole formed in the outer surface of the three-way pipe and aligned with the locating hole of the connector; and
multiple retaining holes formed in the outer surface of the three-way pipe;
a screw screwed through the threaded hole of the three-way pipe and a distal end of the screw inserted into the locating hole of the connector; and
multiple fixers respectively mounted through the retaining holes and being adapted to fix the pressure gauge on the three-way pipe.
